(19) United States
(12) Patent Application Publication
(10) Pub. No.: US 2026/0277048 A1
(43) Pub. Date: Sep. 17, 2026

(54) DISPLAY PANEL

(71) Applicant: HANNSTAR DISPLAY CORPORATION, Taipei City (TW)

(72) Inventors: Shao-Chien CHANG, Taipei City (TW); Chih-Pin LIN, Taipei City (TW); Ling-Chih KAO, Taipei City (TW); Qi-En LUO, Taipei City (TW); Jing-Ya CHIU, Taipei City (TW); Ying-Jung CHEN, Taipei City (TW); Cheng-Yen YEH, Taipei City (TW)

(21) Appl. No.: 19/539,147

(22) Filed: Feb. 13, 2026

(30) Foreign Application Priority Data
Mar. 13, 2025 (TW) 114109342
Jun. 30, 2025 (TW) 114124680

(51) Int. Cl. G02F 1/1335

(52) U.S. Cl. CPC G02F 1/133512; G02F 1/133514

(57) ABSTRACT

A display panel includes a color filter substrate, a pixel array substrate, a black matrix layer, and a spacer. The pixel array substrate is disposed opposite the color filter substrate along a first direction. The pixel array substrate includes a first substrate and a plurality of pixel structures disposed on the first substrate. Each pixel structure has a reflective region and includes a reflective layer disposed in the reflective region. A separation region is disposed between adjacent pixel structures of the plurality of pixel structures. The color filter substrate includes a second substrate and a color filter film disposed on the second substrate. The spacer and the black matrix layer are disposed between the color filter substrate and the pixel array substrate, and the spacer overlaps with the black matrix layer along the first direction.

This application claims the benefits of Taiwan application Serial No. 114109342, filed Mar. 13, 2025 and Taiwan application Serial No. 114124680, filed Jun. 30, 2025, the subject matters of which are incorporated herein by reference.

### BACKGROUND OF THE INVENTION

### Field of the Invention

The invention relates in general to a display panel, and more particularly to a liquid crystal display panel.

### Description of the Related Art

In reflective and transflective display panels, a photoresist layer is provided depending on the color to be displayed by the subpixel. If white is to be displayed, no photoresist layer is provided. Generally, the photoresist layer is provided on a color filter substrate. After components and circuits are fabricated on the pixel array substrate, a planarization layer is formed to flatten the surface of the pixel array substrate.

Although the planarization layer is provided in reflective and transflective display panels, there are still height differences between different subpixels. This height difference reduces the reflectivity of the subpixels. Furthermore, this height difference affects the cell gap and causes abnormal liquid crystal alignment, resulting in dark state light leakage.

### SUMMARY OF THE INVENTION

The invention is directed to a display panel provided to solve the problems of dark state light leakage and reflectivity.

According to one aspect of the present invention, a display panel is provided, including a color filter substrate, a pixel array substrate, a black matrix layer, and a spacer. The pixel array substrate is disposed opposite the color filter substrate along a first direction. The pixel array substrate includes a first substrate and a plurality of pixel structures disposed on the first substrate. Each pixel structure has a reflective region and includes a reflective layer disposed in the reflective region. A separation region is disposed between adjacent pixel structures of the plurality of pixel structures. The color filter substrate includes a second substrate and a color filter film disposed on the second substrate. The spacer and the black matrix layer are disposed between the color filter substrate and the pixel array substrate, and the spacer overlaps with the black matrix layer along the first direction.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a cross-sectional view of a display panel according to one embodiment of the present invention.

FIG. 2A illustrates a cross-sectional view of a display panel according to another embodiment of the present invention.

FIG. 2B illustrates a cross-sectional view of a display panel according to a variant embodiment of FIG. 2A.

FIGS. 3A to 3D are schematic top views of some embodiments of the display panels of FIGS. 2A and 2B.

FIGS. 4A and 4B are schematic top views of other embodiments of the display panels of FIGS. 2A and 2B.

FIG. 5A is a schematic top view of a transflective display panel according to a first embodiment of the invention.

FIG. 5B is a schematic cross-sectional view of an embodiment of the transflective display panel of FIG. 5A.

FIG. 5C is a schematic cross-sectional view of another embodiment of the transflective display panel of FIG. 5A.

### DETAILED DESCRIPTION OF THE INVENTION

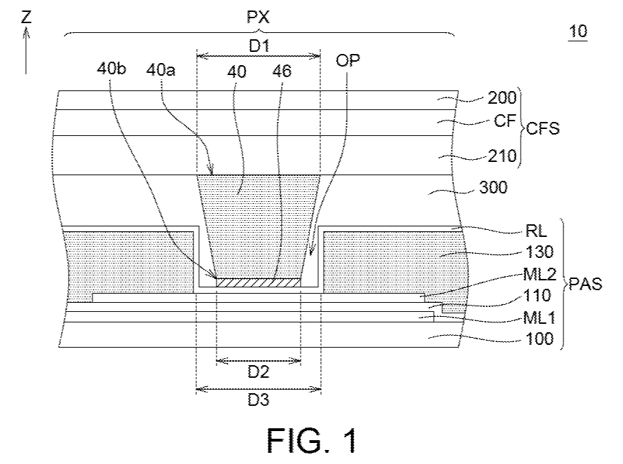

The display panel disclosed in the present invention can be referred to as a reflective display panel, or a transflective display panel. Referring to FIG. 1, a cross-sectional view of a liquid crystal display panel 10 according to an embodiment of the present invention is shown. The liquid crystal display panel 10 includes a color filter substrate CFS, a pixel array substrate PAS, a liquid crystal layer 300, and a spacer 40. The pixel array substrate PAS is disposed opposite the color filter substrate CFS along a first direction Z. To be specific, the pixel array substrate PAS overlaps with the color filter substrate CFS along the first direction Z. Unless otherwise mentioned below, the overlapping relationship between two components is defined in the same way, and an overlapping direction thereof will not be repeated again. The liquid crystal layer 300 and the spacer 40 are disposed between the color filter substrate CFS and the pixel array substrate PAS. A first end 40a of the spacer 40 is located on the color filter substrate CFS, and a second end 40b of the spacer 40 corresponds to a pixel structure PX of the pixel array substrate PAS.

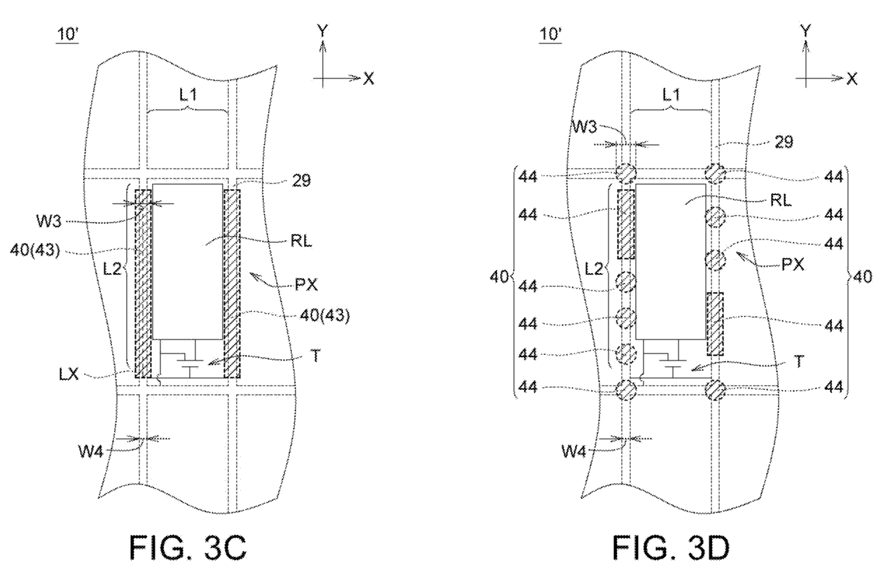

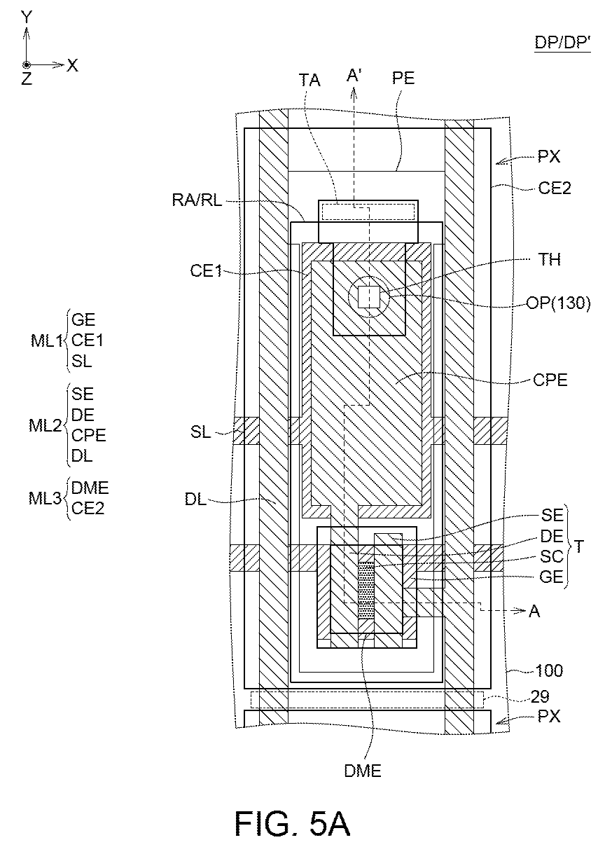

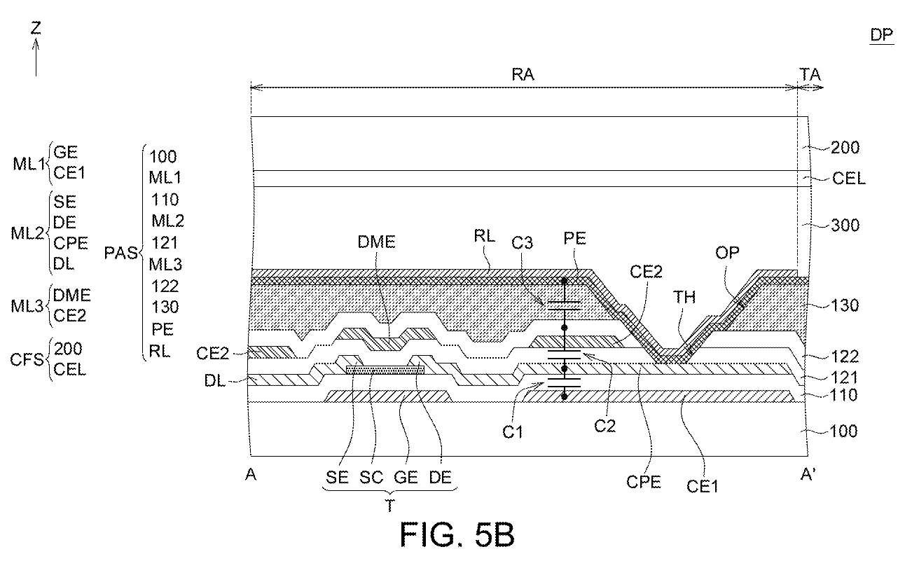

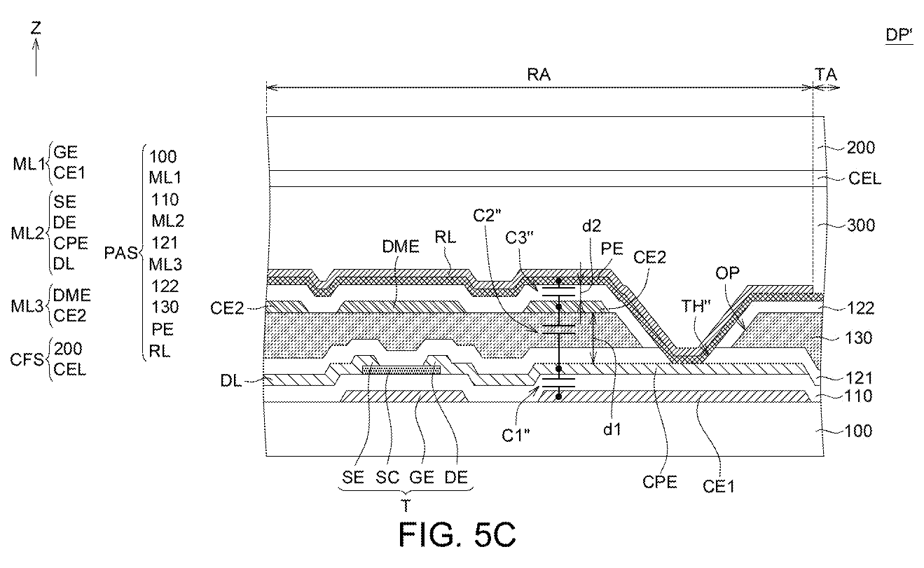

Referring to FIG. 1, the pixel array substrate PAS may include a first substrate 100, a thin film transistor (not shown in FIG. 1, referring to the thin film transistors T of FIGS. 3A to 3D and 5A to 5C), a reflective layer RL, and an insulating layer 130 (or may be referred to as an overcoat layer 130). The insulating layer 130 may serve as a planarization layer to planarize a surface of the pixel array substrate PAS facing the liquid crystal layer 30, but the present disclosure is not limited thereto. The color filter substrate CFS may include a second substrate 200, a color filter film CF, and a planarization layer 210 covering the second substrate 200 and the color filter film CF. The color filter film CF may be, for example, a photoresist layer for displaying red, yellow, blue, green, and other colors, but the present disclosure is not limited thereto.

Generally, the thin film transistor is disposed on the first substrate 100 and is electrically connected to a pixel electrode (not shown in FIG. 1, referring to the pixel electrode PE of FIGS. 5A to 5C). The thin film transistor may include a first metal layer ML1, an insulating layer 110, and a second metal layer ML2, disposed sequentially from bottom to top. The first metal layer ML1 may include a gate of the thin film transistor within each pixel structure PX, the second metal layer ML2 may include a source and a drain of the thin film transistor within each pixel structure PX, and the insulating layer 110 may include a gate insulating layer of the thin film transistor.

For simplicity, FIG. 1 does not illustrate the complete structure of the thin film transistor. Referring to FIG. 1, in one embodiment, only the first metal layer ML1, the first insulating layer 110, and the second metal layer ML2 located in the pixel structure PX are illustrated, and the rest are omitted. The insulating layer 110 may be silicon nitride, silicon oxide, silicon oxynitride, or other suitable insulating layers, and the insulating layer 110 in the figure may include two or more insulating layers made of different materials and stacked to each other. Each of the first and second metal layers ML1 and ML2 may include a single metal layer such as aluminum, copper, titanium, or tungsten, or a composite metal layer such as molybdenum/aluminum/molybdenum, titanium/aluminum-titanium, titanium/copper/titanium, or titanium/copper, or a composite conductive film layer such as indium tin oxide/silver or indium tin oxide/silver/indium tin oxide, but the present invention is not limited thereto.

Referring to FIG. 1, after the thin film transistor circuit is fabricated, the insulating layer 130 is formed on the thin film transistor to planarize the surface of the pixel array substrate PAS facing the liquid crystal layer 300. The thickness of the insulating layer 130 may be greater than 2 μm, but the present invention is not limited thereto. The insulating layer 130 has a via OP to expose the second metal layer ML2 of the pixel array substrate PAS, which is the source or drain of the thin film transistor. The via OP has an inner diameter D3, for example, between 8 μm and 20 μm. Enlarging the inner diameter D3 of the via OP can avoid the problem of vacuum bubbles. For example, when the inner diameter of the via OP is too small (e.g., 4 μm) and the thickness of the insulating layer 130 is too thick, it is not conducive to the liquid crystal layer 300 to diffuse and fill the via OP, resulting in a long diffusion time of the liquid crystal layer 300 and the problem of vacuum bubbles.

In addition, enlarging the inner diameter D3 of the via OP can facilitate the subsequent fabrication of the spacer 40. Referring to FIG. 1, the reflective layer RL is located on one side of the insulating layer 130 and covers the via OP. The reflective layer RL can extend downward through the via OP to the second metal layer ML2, so that the reflective layer RL can be electrically connected to the second metal layer ML2.

The material of the pixel electrode may include indium tin oxide (ITO), indium zinc oxide (IZO), antimony tin oxide (ATO), fluorine tin oxide (FTO), or other transparent conductive layers. The reflective layer RL is, for example, a metal or an opaque conductive layer. In one embodiment, the reflective layer RL may include a stack of composite conductive film layers, such as indium tin oxide/silver/indium tin oxide, or indium tin oxide/silver. The liquid crystal display panel 10 may be a reflective display panel or a transflective display panel, each pixel structure PX has a reflective region, and the reflective layer RL is disposed in the reflective region and configured to reflect ambient light and/or light of a front-light module to display a corresponding image.

In addition, the spacer 40 is disposed opposite the via OP, that is, the spacer 40 can be inserted into the via OP or placed over the via OP. The spacer 40 may further include a light absorbing layer 46 located at one end (i.e., 40b) of the spacer 40, but the present disclosure is not limited thereto.

In one embodiment, the spacer 40 may be a photoresist material to maintain the cell gap between the pixel array substrate PAS and the color filter substrate CFS. The cell gap may be greater than or equal to 2 μm and less than or equal to 2.8 μm. Furthermore, the light-absorbing layer 46 may be a black light-absorbing material or a black photoresist material mixed into the spacer 40. Alternatively, the light-absorbing layer 46 may be a black light-absorbing material coated on the end of the spacer 40. For example, the light-absorbing layer 46 disposed on the end of spacer 40 may be a black matrix layer comprising the black light-absorbing material, and the black matrix layer overlaps with the spacer 40 along the first direction Z. Alternatively, the spacer 40 may be a black light-absorbing material or a black photoresist to enhance the light-absorbing effect.

Referring to FIG. 1, the light-absorbing layer 46 may be disposed at the end of the spacer 40, and the position of the light-absorbing layer 46 may overlap with the reflective layer RL located within the via OP in the first direction Z. Furthermore, the size of the spacer 40 may be slightly smaller than or equal to the size of the via OP. For example, the radial dimension of the spacer 40 relative to the via OP may be smaller than or equal to the inner diameter D3 of the via OP. The spacer 40 is, for example, a columnar body or other suitable structure. The first end 40a of the space 40 has a first dimension D1, and the second end 140b thereof has a second dimension D2. The first dimension D1 may be greater than or equal to the second dimension D2. The first dimension D1 is, for example, substantially equal to the inner diameter D3 of the via OP, and the second dimension D2 is, for example, less than the inner diameter D3 of the via OP.

In summary, the liquid crystal display panel 10 of the present embodiment includes a light-absorbing layer 46 and the spacer 40 disposed within the via OP of the insulating layer 130 to absorb dark state light leakage, thereby resolving the problem of dark state brightness around the via OP.

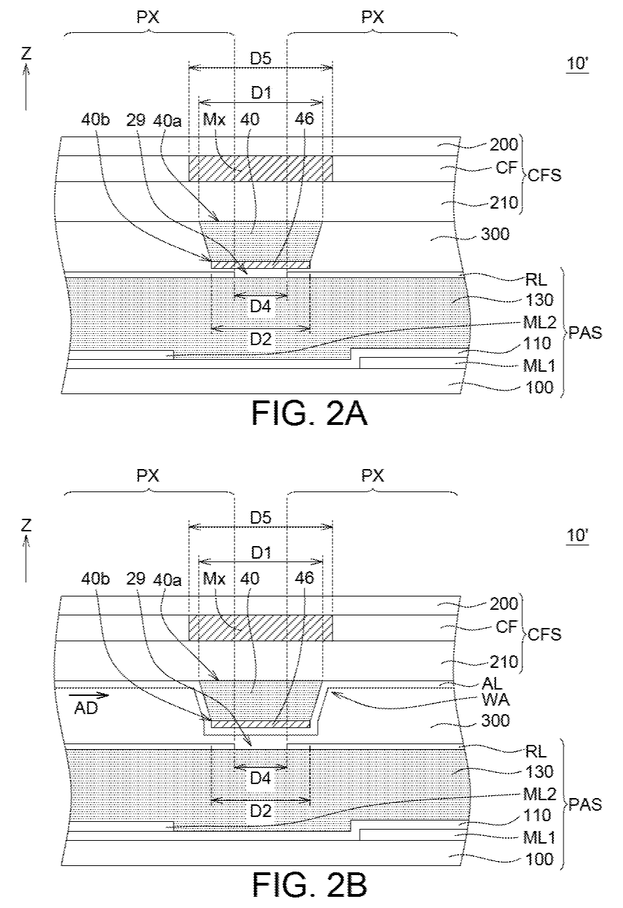

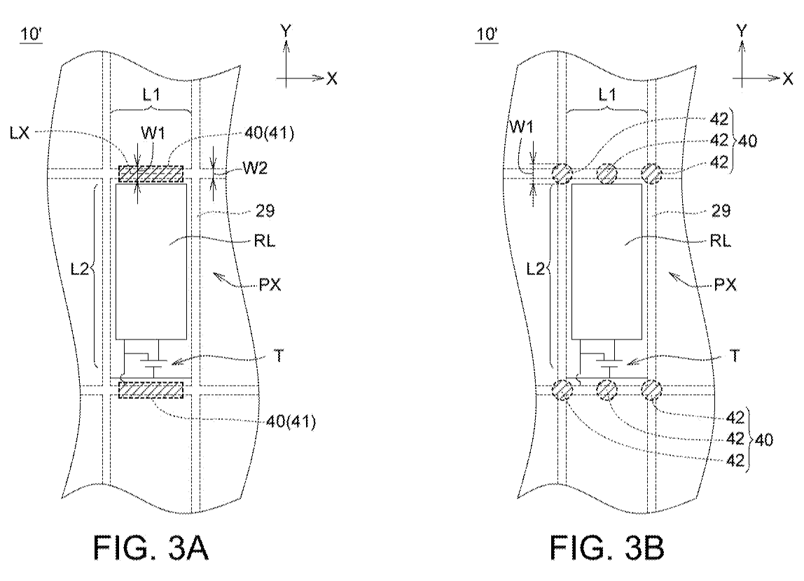

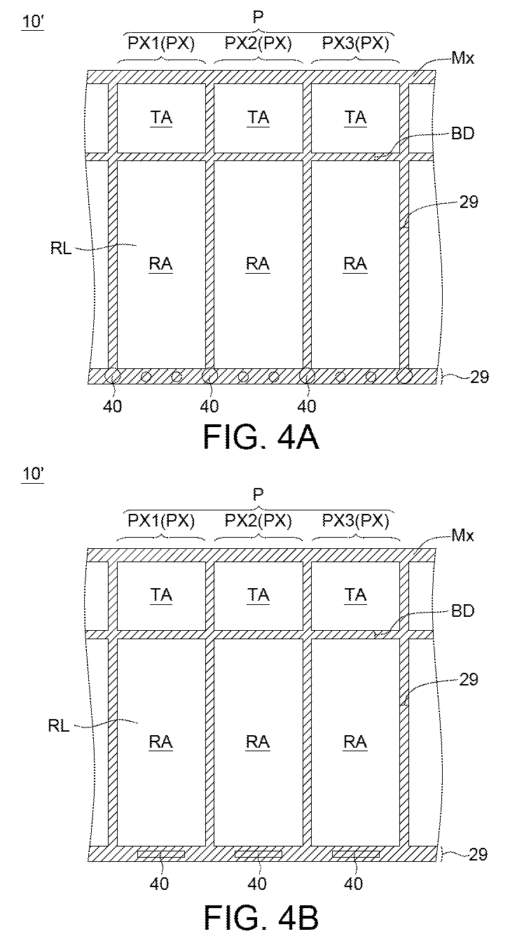

FIG. 2A is a cross-sectional view of a display panel according to another embodiment of the present invention. FIG. 2B is a cross-sectional view of a display panel according to a variant embodiment of FIG. 2A. FIGS. 3A to 3D are schematic top views of some embodiments of the display panels of FIGS. 2A and 2B. FIGS. 4A and 4B are schematic top views of other embodiments of the display panels of FIGS. 2A and 2B. Referring to FIG. 2A, a cross-sectional view of a liquid crystal display panel 10′ according to another embodiment of the present invention is shown. The liquid crystal display panel 10′ includes a color filter substrate CFS, a pixel array substrate PAS, a liquid crystal layer 300, and a spacer 40. The pixel array substrate PAS and the color filter substrate CFS are disposed opposite each other. The liquid crystal layer 300 and the spacer 40 are disposed between the color filter substrate CFS and the pixel array substrate PAS. The first end 40a of the spacer 40 is located on the color filter substrate CFS, and the second end 40b of the spacer 40 corresponds to the periphery of a pixel structure PX of the pixel array substrate PAS.

Referring to FIG. 2A, the pixel array substrate PAS may include a first substrate 100, a thin film transistor (not shown in FIG. 2A, referring to the thin film transistors T of FIGS. 3A to 3D and 5A to 5C), a reflective layer RL, and an insulating layer 130. The color filter substrate CFS may include a second substrate 200, a color filter film CF, and a planarization layer 210 covering the second substrate 200 and the color filter film CF. The color filter film CF may be, for example, a photoresist layer for displaying red, yellow, blue, green, and other colors, but the present disclosure is not limited thereto.

Generally, the thin film transistor is disposed on a first substrate 100 and is electrically connected to a pixel electrode (not shown). The thin film transistor may include a first metal layer ML1, an insulating layer 110, and a second metal layer ML2, disposed sequentially from bottom to top. The first metal layer ML1 may include a gate of the thin film transistor located in each pixel structure PX. The second metal layer ML2 may include a source and a drain of the thin film transistor located in each pixel structure PX.

For simplicity, FIG. 2A does not illustrate the complete structure of the thin film transistor. Referring to FIG. 2A, in the present embodiment, only the first metal layer ML1, the insulating layer 110, and the second metal layer ML2 located in the pixel structure PX are illustrated, and the rest are omitted. The insulating layer 110 may be silicon nitride, silicon oxide, silicon oxynitride, or other suitable insulating layer, and the insulating layer 110 in the figure may include two or more insulating layers made of different materials and stacked to each other. Each of the first and second metal layers ML1 and ML2 may comprise a single metal layer such as aluminum, copper, titanium, or tungsten, or composite metal layers such as molybdenum/aluminum/molybdenum, titanium/aluminum-titanium, titanium/copper/titanium, or titanium/copper, or composite conductive film layers such as indium tin oxide/silver or indium tin oxide/silver/indium tin oxide, but the present invention is not limited thereto.

Referring to FIG. 2A, after the circuit fabrication of the thin film transistor is completed, an insulating layer 130 is formed on the thin film transistor to planarize the surface of the pixel array substrate PAS facing the liquid crystal layer 300. The thickness of the planarization layer 130 may be greater than 2 μm, but the present invention is not limited thereto. A separation region 29 is disposed between adjacent pixel structures PX. As shown in FIG. 2A, the reflective layer RL of the pixel structure PX extends to an edge of the pixel structure PX, therefore, a gap between the reflective layers RL of adjacent pixel structures PX is the separation region 29, but the present disclosure is not limited thereto.

Although not shown in FIG. 2A, the pixel electrode can extend downward through a via to the second metal layer ML2 so that the pixel electrode can be electrically connected to the source or drain of the thin film transistor (referring to the pixel electrode PE of FIGS. 5B and 5C). The material of the pixel electrode may include indium tin oxide (ITO), indium zinc oxide (IZO), antimony tin oxide (ATO), fluorine tin oxide (FTO), or other transparent conductive layers. The reflective layer RL is, for example, a metal or an opaque conductive layer. In one embodiment, the reflective layer RL may include a stack of composite conductive film layers, such as indium tin oxide/silver/indium tin oxide, or indium tin oxide/silver.

Referring to FIG. 2A, the difference between this embodiment and the above embodiment is that the spacer 40 is disposed opposite the separation region 29, that is, the spacer 40 is located above the separation region 29. The spacer 40 may further include a light-absorbing layer 46 located at one end of the spacer 40, but the present disclosure is not limited thereto.

In one embodiment, the spacer 40 may be a photoresist material to maintain the cell gap between the pixel array substrate PAS and the color filter substrate CFS. The cell gap may be greater than or equal to 2 μm and less than or equal to 2.8 μm. In addition, the light absorbing layer 46 may be a black light absorbing material or a black photoresist material mixed into the spacer 40. In addition, the light-absorbing layer 46 may also be a black light absorbing material coated on the end of the spacer 40. For example, the light-absorbing layer 46 disposed on the end of the spacer 40 may be a black matrix layer comprising the black light-absorbing material, and the black matrix layer overlaps with the spacer 40 along the first direction Z. In addition, the spacer 40 may also be a black light absorbing material or a black photoresist to enhance the light absorption effect.

Referring to FIG. 2A, the light-absorbing layer 46 may be disposed at the end of the spacer 40, and the position of the light-absorbing layer 46 may overlap with the separation region 29 in the first direction Z. In addition, the size of the spacer 40 may be slightly greater than or equal to the size of the separation region 29, but the present disclosure is not limited thereto. For example, the lateral size of the spacer 40 may be greater than or equal to the lateral size of the separation region 29 (i.e., the spacing distance D4 between adjacent pixel structures PX). The spacer 40 is, for example, a columnar body or other suitable structure. The first end 40a of the spacer 40 has a first dimension D1, and the second end 40b thereof has a second dimension D2. In the embodiment, the spacer 40 may be disposed on the color filter substrate CFS before the pixel array substrate PAS and the color filter substrate CFS are assembled to form the liquid crystal display panel 10′, therefore, the first dimension D1 may be greater than or equal to the second dimension D2, but the present disclosure is not limited thereto. The first dimension D1 and the second dimension D2 may be referred to as a width of the first end 40a and a width of the second end 40b of the spacer 40, respectively. The first dimension D1 may be greater than the lateral dimension (or width, i.e., the spacing distance D4 between adjacent pixel structures PX) of the separation region 29, and the second dimension D2 may be substantially greater than or equal to the lateral dimension (or width, i.e., the spacing distance D4 between adjacent pixel structures PX) of the separation region 29.

In one embodiment, the spacer 40 including the light-absorbing layer 46 is disposed above the reflective layer RL and opposite the separation region 29 to absorb dark state leakage light between adjacent pixel structures PX, thereby resolving the problem of dark state brightness around the pixel structure PX.

In addition, the color filter substrate CFS may further include a black matrix layer Mx. The black matrix layer Mx overlaps with the spacer 40 and the separation region 29 along the first direction Z. Referring to FIG. 2B, the color filter substrate CFS may further include an alignment layer AL, and the alignment layer AL may be disposed between the planarization layer 210 and the liquid crystal layer 300 and between the spacer 40 and the liquid crystal layer 300, since there is a significant height difference between the spacer 40 and a film surface on which the spacer 40 stands (e.g., the planarization layer 210), during an alignment process (e.g., a rubbing process for alignment) of the alignment layer AL, an alignment effect to a part of the alignment layer AL shielded by the spacer 40 along an alignment direction AD is reduced, thereby affecting the arrangement state of a part of the liquid crystal layer 300 located in a region near the spacer 40 (e.g., a weak alignment region WA located near the spacer 40), causing the phenomenon of light leakage in the weak alignment region WA. The light leakage in the weak alignment region WA may be shielded by the black matrix layer Mx overlapping the spacer 40. A width D5 of the black matrix layer Mx is greater than the width of the spacer 40 (i.e., the width D5 of the black matrix layer Mx is greater than the first dimension D1 and the second dimension D2 of the spacer 40). In other words, an orthogonal projection of the spacer 40 on the second substrate 200 is located within an orthogonal projection of the black matrix layer Mx on the second substrate 200. It is noted that in a variant embodiment of FIG. 1, the liquid crystal display panel 10 may further include a black matrix layer Mx overlapping with the spacer 40 to shield the light leakage in the weak alignment region near the spacer 40.

Referring to FIGS. 3A to 3D, top views of the spacer 40 disposed corresponding to the separation region 29 are respectively illustrated. For simplicity, FIGS. 3A to 3D omit illustrating the black matrix layer Mx of FIGS. 2A and 2B. In one embodiment, the pixel structure PX is, for example, in a rectangular pattern, and the separation region 29 is disposed around the pixel structure PX. That is, adjacent pixel structures PX can be separated by the separation region 29. The separation region 29 may be referred to as a street region that surrounds the pixel structure PX. As shown in FIGS. 3A to 3D, the separation region 29 includes, for example, a first side region L1 and a second side region L2. The first side region L1 extends along a second direction X, and the second side region L2 extends along a third direction Y. The second direction X intersects with the third direction Y, and each of the second direction X and the third direction Y is perpendicular to the first direction Z. In this embodiment, the first side region L1 and the second side region L2 are arranged orthogonally, and the spacer 40 is disposed along at least one of the first side region L1 and the second side region L2.

Referring to FIGS. 3A to 3D, the first side region L1 is, for example, located at a short side region around the pixel structure PX, and the second side region L2 is, for example, located at a long side region around the pixel structure PX. The first side region L1 and the second side region L2 are connected to form a rectangular pattern. As shown in FIG. 3A, the spacers 40 include two spacers 41 disposed on two opposing first side regions L1, respectively, and each of the spacers 41 extends substantially along the length direction (i.e., the second direction X) of the first side region L1. The spacer 41 may be long-strip shaped (e.g., rectangular) or has other shapes, and the width W1 of each of the spacers 41 is substantially greater than or equal to the width W2 of the first side region L1. In FIG. 3A, the spacer 41 has a long-strip shape in a plan view of the liquid crystal display panel 10′, and the long-strip shape has a long axis LX parallel to the second direction X.

As shown in FIG. 3B, the spacers 40 include a plurality of spacers 42 disposed on two opposing first side regions L1, the number of which may include, but is not limited to, six spacers. The spacers 42 are arranged in two rows substantially along the length direction (i.e., the second direction X) of the first side region L1. The spacer 42 may be circular or have other shapes, and the width W1 (or diameter) of the spacer 42 is substantially greater than or equal to the width W2 of the first side region L1.

As shown in FIG. 3C, the spacers 40 include two spacers 43 respectively disposed on two opposing second side regions L2, and each of the spacers 43 extends substantially along the longitudinal direction (i.e., the third direction Y) of the second side regions L2. The shape of the spacer 43 can be long-strip shaped (e.g., rectangular) or has other shape, and the width W3 of each of the spacers 43 is substantially greater than or equal to the width W4 of the second side region L2. In FIG. 3C, the spacer 43 has a long-strip shape in the plan view of the liquid crystal display panel 10′, and the long-strip shape has a long axis LX parallel to the third direction Y.

As shown in FIG. 3D, the spacers 40 include a plurality of spacers 44 disposed on two opposing second side regions L2, and the spacers 44 are arranged substantially along the length direction (i.e., the third direction Y) of the second side region L2. The shapes of the spacers 44 may include circular shape, long-strip shape, or a combination thereof, and the width W3 (or diameter) of each of the spacers 44 is substantially greater than or equal to the width W4 of the second side region L2.

As described in the aforementioned embodiment of FIG. 2B, the weak alignment region WA is formed near the spacer 40 after the alignment process (e.g., a rubbing process for alignment) of the alignment layer AL of the color filter substrate CFS is performed. In order to reduce an area of the weak alignment region WA, the arrangement of the spacer 40 may adopt the arrangement of the spacer 41 of FIG. 3A in an embodiment in which the alignment direction AD of the alignment layer AL is parallel to the second direction X, and the arrangement of the spacer 40 may adopt the arrangement of the spacer 43 of FIG. 3C in an embodiment in which the alignment direction AD of the alignment layer AL is parallel to the third direction Y. In other words, the long axis LX of the spacer 40 is parallel to the alignment direction AD, thereby reducing the area of the weak alignment region WA.

Referring to FIGS. 4A and 4B, top views of the spacer 40 disposed in a separation region 29 are respectively illustrated. In FIGS. 4A and 4B, the pixel P may be composed of three pixel structures PX1-PX3, each of which corresponds to a color filter film (e.g., a red, green, or blue filter film). Each of the pixel structures PX1-PX3 of the pixel P has a reflective region RA and a transmissive region TA. The reflective layer RL is disposed in the reflective region RA and is not disposed in the transmissive region TA, and a pixel electrode (not shown in FIGS. 4A and 4B, referring to the pixel electrode PE of FIGS. 5A to 5C) comprising a transparent conductive material is disposed in the reflective region RA and the transmissive region TA, therefore, ambient light and/or light of a front-light module may be reflected by the reflective layer RL disposed in the reflective region RA to form reflective light, and light of a backlight module may penetrate the pixel electrode disposed in the transmissive region TA to form transmissive light. To be specific, the display panel including the pixel structures PX1-PX3 of FIGS. 4A and 4B is a transflective display panel. The reflective region RA, the transmissive region TA and the arrangement of the reflective layer RL and the pixel electrode will be clearly presented in the following detailed description of an embodiment with reference to the FIGS. 5A to 5C. The separation region 29 is disposed corresponding to the black matrix layer Mx of the color filter substrate CFS (i.e., the separation region 29 overlaps with the black matrix layer Mx). In this embodiment, a cell gap in the reflective region RA may be greater than a cell gap in the transmissive region TA (i.e., the liquid crystal display panel 10′ is a transflective display panel having dual cell gaps), thereby reducing the optical path difference between the reflective light in the reflective region RA and the transmissive light in the transmissive region TA. Therefore, the black matrix layer Mx may further overlap with a border BD between the reflective region RA and the transmissive region TA to shield the light leakage in the border BD. In other words, the black matrix layer Mx (indicated by diagonal lines) separates adjacent pixel structures PX from each other and separates the reflective region RA from the transmissive region TA to reduce light mixing between adjacent pixel structures PX and light leakage in the border BD. Furthermore, the spacers 40 may be disposed along the extending direction of the separation region 29. The shapes of the spacers 40 may include circular shape, long-strip shape, or a combination thereof, but the invention is not limited thereto. The spacer 40 overlaps the black matrix layer Mx. In FIGS. 4A and 4B, it is illustrated that the spacer 40 is disposed corresponding to the separation region 29 between adjacent pixels P, but the invention is not limited thereto. In other embodiments, the spacer 40 may be disposed corresponding to the separation region 29 between adjacent pixel structures PX of the pixel P and overlap with the black matrix layer Mx, or may be disposed corresponding to the border BD between the reflective region RA and the transmissive region TA and overlap with the black matrix layer Mx.

FIG. 5A is a schematic top view of a transflective display panel according to a first embodiment of the invention. FIG. 5B is a schematic cross-sectional view of an embodiment of the display panel of FIG. 5A. FIG. 5C is a schematic cross-sectional view of another embodiment of the transflective display panel of FIG. 5A. Each of FIGS. 5B and 5C corresponds to a line A-A′ in FIG. 5A. For the sake of clarity, FIG. 5A omits illustration of a color filter substrate CFS and a liquid crystal layer 300 in FIGS. 5B and 5C.

Referring to FIGS. 5A and 5B, a display panel DP includes a pixel array substrate PAS, a color filter substrate CFS and a liquid crystal layer 300. The liquid crystal layer 300 is disposed between the pixel array substrate PAS and the color filter substrate CFS. Namely, the display panel DP of the embodiment is a liquid crystal display panel.

The pixel array substrate PAS includes a first substrate 100 and a plurality of scan lines SL, a plurality of data lines DL and a plurality of pixel structures PX disposed on the first substrate 100. The pixel structure PX is electrically connected to one of the scan lines SL and one of the data lines DL. It should be noted that FIG. 5A only shows one pixel structure PX of the display panel DP, and the display panel DP may be formed by arranging a plurality of the pixel structures PX. For example, the plurality of data lines DL may be arranged along a second direction X, each of the data lines DL may extend in a third direction Y, the plurality of scan lines SL may be arranged along the third direction Y, and each of the scan lines SL may extend in the second direction X, where the second direction X is optionally perpendicular to the third direction Y. The plurality of pixel structures PX may be arranged in a plurality of columns and rows along the second and third directions X and Y, respectively.

The pixel structure PX includes a thin film transistor T, a first common electrode CE1, a capacitor electrode CPE, a second common electrode CE2 and a pixel electrode PE. The thin film transistor T has a source SE, a drain DE, a gate GE and a semiconductor pattern SC. The source SE is electrically connected to a corresponding data line DL. The drain DE is electrically connected to the capacitor electrode CPE. The gate GE is electrically connected to a corresponding scan line SL. More specifically, an extending portion of the scan line SL corresponding to the pixel structure PX may be used as the gate GE of the thin film transistor T, and an extending portion of the data line DL corresponding to the pixel structure PX may be used as the source SE of the thin film transistor T. The capacitor electrode CPE extends from the drain DE and is electrically connected to the pixel electrode PE.

The first common electrode CE1 is disposed between the capacitor electrode CPE and the first substrate 100, and overlaps the capacitor electrode CPE along a first direction Z. The second common electrode CE2 is disposed between the capacitor electrode CPE and the pixel electrode PE, and overlaps the pixel electrode PE and the capacitor electrode CPE along the first direction Z. For example, the first common electrode CE1 may be electrically coupled to the capacitor electrode CPE and form a first storage capacitor C1 (i.e., the first storage capacitor C1 is formed by the first common electrode CE1, the capacitor electrode CPE, and at least one insulating film layer located between the above two electrodes). The capacitor electrode CPE may be electrically coupled to the second common electrode CE2 and form a second storage capacitor C2 (i.e., the second storage capacitor C2 is formed by the capacitor electrode CPE, the second common electrode CE2 and at least one insulating film layer located between the above two electrodes). The second common electrode CE2 may be electrically coupled to the pixel electrode PE and form a third storage capacitor C3 (i.e., the third storage capacitor C3 is formed by the second common electrode CE2, the pixel electrode PE, and at least one insulating film layer between the above two electrodes). More specifically, the storage capacitor of the pixel structure PX may be formed by connecting the first storage capacitor C1, the second storage capacitor C2 and the third storage capacitor C3 in parallel. For example, the first storage capacitor C1 is formed by the first common electrode CE1, the capacitor electrode CPE and an insulating layer 110 disposed between the first common electrode CE1 and the capacitor electrode CPE. The second storage capacitor C2 is formed by the capacitor electrode CPE, the second common electrode CE2 and a first passivation layer 121 disposed between the capacitor electrode CPE and the second common electrode CE2. The third storage capacitor C3 is formed by the second common electrode CE2, the pixel electrode PE, and a second passivation layer 122 and an insulating layer 130 disposed between the second common electrode CE2 and the pixel electrode PE. The insulating layer 130 may serve as a planarization layer. The first passivation layer 121 and the second passivation layer 122 has a contact hole TH exposing the capacitor electrode CPE, the insulating layer 130 has a via OP overlapping the contact hole H. The pixel electrode PE extends into the via OP of the insulating layer 130 and is electrically connected with the capacitor electrode CPE through the contact hole TH. In the embodiment, the pixel electrode PE is, for example, a light-transmissive electrode, and a material of the light-transmissive electrode may include a transparent conductive material. For example, the transparent conductive material may include metal oxides (for example, indium tin oxide, indium zinc oxide, aluminum tin oxide, aluminum zinc oxide, or other suitable oxides, or a stacked layer of at least two of the above oxides), but the invention is not limited thereto.

In the embodiment, the pixel structure PX may have a reflective region RA and a transmissive region TA. The pixel electrode PE overlaps the reflective region RA and the transmissive region TA. The pixel structure PX may further include a reflective layer RL disposed in the reflective region RA, and the reflective layer RL covers and is electrically connected to the pixel electrode PE. From another point of view, the reflective region RA of the pixel structure PX may be defined by the location of the reflective layer RL. It should be particularly noted that a part of the pixel electrode PE overlaps the reflective layer RL in the reflective region RA, and another part overlaps the transmissive region TA. Namely, the display panel DP of the embodiment may be a transflective display panel. However, the invention is not limited thereto. According to other embodiments, the pixel structure may only have the reflective region RA without the transmissive region TA, i.e., the display panel may also be a reflective display panel. As shown in FIG. 5A, a separation region 29 is formed between adjacent pixel structures PX. For the sake of clarity, FIGS. 5A to 5C omit illustration of the spacer and the black matrix layer. Similar to FIGS. 2A and 2B, 3A to 3D and 4A and 4B, the spacer (not shown) may be disposed in the separation region 29. In addition, the black matrix layer (not shown) may be disposed in the separation region 29 and the border BD between the reflective region RA and the transmissive region TA (referring to FIGS. 4A and 4B), and the spacer may be disposed corresponding to the black matrix layer. Therefore, the spacer is not disposed in the reflective region RA and the transmissive region TA, thereby preventing the spacer from blocking the reflective region RA and the transmissive region TA and affecting the reflectivity and transmittance. In addition, similar to FIG. 1, the spacer (not shown) may be disposed corresponding to the via OP of the insulating layer 130 (i.e., the spacer overlaps with the via OP), and the black matrix layer may overlap with the spacer.

On the other hand, in order to reduce a coupling effect between the thin film transistor T and the pixel electrode PE to prevent a potential of the pixel electrode PE from causing turning-on of the thin film transistor T to cause leakage, a dummy electrode DME may be further provided between the thin film transistor T and the pixel electrode PE. The dummy electrode DME overlaps the thin film transistor T along the first direction Z. For example, the dummy electrode DME may have a floating potential, but the invention is not limited thereto.

The color filter substrate CFS may include a second substrate 200 and a common electrode layer CEL disposed on a surface of the second substrate 200 facing the liquid crystal layer 300, i.e., the common electrode layer CEL is disposed between the second substrate 200 and the liquid crystal layer 300. For example, in the embodiment of the transflective display panel, the common electrode layer CEL is disposed in the reflective region RA and the transmissive region TA; in the embodiment of the reflective display panel without the transmissive region TA, the common electrode layer CEL is disposed in the reflective region RA. A material of the common electrode layer CEL may include a transparent conductive material, and the transparent conductive material may include, for example, metal oxide (for example, indium tin oxide, indium zinc oxide, aluminum tin oxide, aluminum zinc oxide, or other suitable oxides, or a stacked layer of at least two of the above oxides), but the invention is not limited thereto. For example, an electric field formed between the pixel electrode PE and the common electrode layer CEL may control a direction of liquid crystal molecules in the liquid crystal layer 300 to display a corresponding image. In the embodiment, the common electrode layer CEL, the first common electrode CE1 and the second common electrode CE2 may receive a common voltage, but the invention is not limited thereto. In addition, the color filter substrate CFS may further include a color filter film and a planarization layer (not shown) disposed on the second substrate 200 (referring to the color filter film CF and the planarization layer 210 in FIGS. 1 and 2).

Referring to FIGS. 5B and 5C at the same time, regarding the display panel DP of FIG. 5B, since the thickness of the first passivation layer 121 (i.e., the thickness of the first passivation layer 121 in the first direction Z) between the third metal layer ML3 and the second metal layer ML2 is thinner, a capacitive coupling effect between the second common electrode CE2 and the data line DL may be more significant, and a waveform of a potential signal transmitted on the data line DL is easily affected and changed by the above capacitive coupling effect, which causes a problem of insufficient charge and discharge of the pixel structure PX. In order to further mitigate this problem, in the display panel DP′ of FIG. 5C, a stacking sequence of the third metal layer ML3, the second passivation layer 122 and the insulating layer 130 is adjusted to sequentially dispose the insulating layer 130, the third metal layer ML3 and the second passivation layer 122 (referring to FIG. 5C, the insulating layer 130 is disposed below the third metal layer ML3, and the second passivation layer 122 is disposed above the third metal layer ML3). More specifically, in FIG. 5C, the insulating layer 130 of the display panel DP′ is disposed between the thin film transistor T and the third metal layer ML3 (i.e., the insulating layer 130 of the display panel DP′ is disposed between the second metal ML2 and the third metal layer ML3), and the second passivation layer 122 is disposed on the insulating layer 130 and covers the third metal layer ML3. Therefore, the first passivation layer 121 and the insulating layer 130 are disposed between the third metal layer ML3 and the second metal layer ML2, and the capacitive coupling effect between the second common electrode CE2 and the data line DL is reduced in the second embodiment since a distance between the data line DL and the second common electrode CE2 is increased.

Since the film structures of the first metal layer ML1, the second metal layer ML2, the third metal layer ML3, the pixel electrode PE and the reflective layer RL and the overlapping relationship in the top view direction (for example, the first direction Z) of FIG. 5C are all the same as that of the display panel DP of FIG. 5B, the top-view structure of the display panel DP′ of FIG. 5C may refer to FIG. 5A. Similar to FIG. 5B, the first common electrode CE1 is disposed between the capacitor electrode CPE and the first substrate 100 and overlaps the capacitor electrode CPE along the first direction Z. The second common electrode CE2 is disposed between the capacitor electrode CPE and the pixel electrode PE, and overlaps the pixel electrode PE and the capacitor electrode CPE along the first direction Z. For example, the first common electrode CE1 may be electrically coupled to the capacitor electrode CPE and form a first storage capacitor C1” (i.e., the first storage capacitor C1” is formed by the first common electrode CE1, the capacitor electrode CPE, and at least one insulating film layer located between the above two electrodes). The capacitor electrode CPE may be electrically coupled to the second common electrode CE2 and form a second storage capacitor C2” (i.e., the second storage capacitor C2” is formed by the capacitor electrode CPE, the second common electrode CE2 and at least one insulating film layer located between the above two electrodes). The second common electrode CE2 may be electrically coupled to the pixel electrode PE and form a third storage capacitor C3” (i.e., the third storage capacitor C3” is formed by the second common electrode CE2, the pixel electrode PE and at least one insulating film layer located between the above two electrodes). More specifically, a storage capacitor of the pixel structure PX may be formed by connecting the first storage capacitor C1”, the second storage capacitor C2”, and the third storage capacitor C3” in parallel. For example, the first storage capacitor C1” is formed by the first common electrode CE1, the capacitor electrode CPE, and the insulating layer 110 located between the first common electrode CE1 and the capacitor electrode CPE. The second storage capacitor C2” is formed by the capacitor electrode CPE, the second common electrode CE2, and the first passivation layer 121 and the overcoat layer 130A located between the capacitor electrode CPE and the second common electrode CE2. The third storage capacitor C3” is formed by the second common electrode CE2, the pixel electrode PE, and the second passivation layer 122 located between the second common electrode CE2 and the pixel electrode PE.

It is noted that each of FIGS. 1, 2A, 2B, 3A to 3D, 4A and 4B only illustrates a portion of a cross-sectional view of the pixel structure PX of the liquid crystal display panel 10 or 10′ or a portion of a schematic top view of the pixel structure PX of liquid crystal display panel 10′, and the rest not shown may refer to FIGS. 5A to 5C in the embodiment in which the liquid crystal display panel 10 or 10′ is a transflective display panel.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display panel, comprising:
a pixel array substrate, comprising a first substrate and a plurality of pixel structures disposed on the first substrate, wherein each pixel structure has a reflective region and comprises a reflective layer disposed in the reflective region, and a separation region is disposed between adjacent pixel structures of the plurality of pixel structures;
a color filter substrate, disposed opposite to the pixel array substrate along a first direction, wherein the color filter substrate comprises a second substrate and a color filter film disposed on the second substrate, and
a spacer and a black matrix layer, disposed between the color filter substrate and the pixel array substrate, wherein the spacer overlaps with the black matrix layer along the first direction.

2. The display panel of claim 1, wherein the display panel is a reflective display panel or a transflective display panel.

3. The display panel of claim 1, wherein the spacer and the black matrix layer overlap with the separation region along the first direction.

4. The display panel of claim 3, wherein a width of the black matrix layer is greater than a width of the spacer.

5. The display panel of claim 4, wherein an orthogonal projection of the spacer on the second substrate is located within an orthogonal projection of the black matrix layer on the second substrate.

6. The display panel of claim 3, wherein the separation region has a first side region and a second side region, the first side region extends along a second direction, the second side region extends along a third direction, the second direction intersects with the third direction, the spacer overlaps with one of the first side region and the second side region along the first direction, the shape of the spacer is a long-strip shape having a long axis, and the long axis is parallel to the second direction or the third direction.

7. The display panel of claim 6, wherein the color filter substrate further comprises an alignment layer disposed on the second substrate, the alignment layer has an alignment direction, and the long axis is parallel to the alignment direction.

8. The display panel of claim 1, wherein the display panel is a transflective display panel, each pixel structure further has a transmissive region, and the black matrix layer overlaps with a border between the reflective region and the transmissive region along the first direction.

9. The display panel of claim 8, wherein the spacer overlaps with the border along the first direction.

10. The display panel of claim 1, wherein each pixel structure further comprises a thin film transistor and an insulating layer disposed on the first substrate, the insulating layer is disposed above the thin film transistor and has a via, and the spacer overlaps with the via along the first direction.

11. The display panel of claim 1, wherein the black matrix layer is disposed on an end of the spacer.
